(19) United States
(12) Patent Application Publication
(10) Pub. No.: US 2016/0103444 A1
(43) Pub. Date: Apr. 14, 2016

(54) CONTROLLER FOR MACHINE TOOL INCLUDING AUTOMATIC TOOL CHANGER

(71) Applicant: FANUC Corporation, Yamanashi (JP)

(72) Inventor: Yoshitsugu OGAWA, Yamanashi (JP)

(21) Appl. No.: 14/876,987

(22) Filed: Oct. 7, 2015

(30) Foreign Application Priority Data
Oct. 8, 2014 (JP) 2014-207409

(51) Int. Cl. G05B 19/406

(52) U.S. Cl. CPC G05B 19/406; G05B 2219/50047; G05B 2219/34475

(57) ABSTRACT

A controller performs tool indexing operation by controlling a tool post driving motor that drives a tool post that can house a plurality of tools and can position a desired tool to a specific position. At this time, the controller estimates an amount of movement of the tool post driving motor based on the number of a tool pot at a tool change position at the start of tool indexing operation and the number of a tool pot that houses a tool specified to be changed. The controller compares the estimated amount of movement of the motor with an actual amount of movement of the tool post driving motor in tool indexing operation, and thereby detects an abnormality in tool indexing operation.

### BACKGROUND OF THE INVENTION

1. Field of the Invention

The present invention relates to a controller for a machine tool including an automatic tool changer and more particularly to a controller for a machine tool that detects an abnormality in tool indexing operation of an automatic tool changer and provides notification of the abnormality.

2. Description of the Related Art

Many machine tools have an automatic tool changer that automatically changes tools. There are various types of automatic tool changers, in many of which a tool post that can house a plurality of tools is driven by a motor to position a desired tool pot to a specific position, and a tool in a spindle and a tool in the tool post are changed.

A prior art example of a mechanism of a tool changer with a tool post will now be described with reference to FIG. 5A (side view) and FIG. 5B (front view).

A tool post 10 has many tool pots 12 linked by a chain 11, and each tool pot 12 houses a tool 13. For tool selection in the tool post 10, a sprocket 15 is driven by a tool post driving motor 14 to turn the chain 11, the tool pots 12 and the tools 13 housed in the tool pots 12 are turned, and thereby tool selection operation is performed.

A procedure for changing tools with the tool changer illustrated in FIGS. 5A and 5B will be described with reference to FIGS. 6A to 6E.

A tool change arm 16 illustrated in FIG. 6A is used to change the tools 13. The tool change arm 16 includes a mechanism for holding a tool at each end of the tool change arm 16, and is configured to be capable of rotating around the center position (center axis of rotation) of the tool change arm 16.

When a tool change instruction is issued to the controller for the machine tool, a spindle 20 is positioned near the tool post 10. At the same time, the tool post driving motor 14 of the tool changer is driven to turn the chain 11, the tool pot 12 that houses a tool 13A to be changed moves to a tool change position, and a tool 13B attached to the spindle 20 and the tool 13A at the tool change position are held by the tool change arm 16 (FIG. 6B).

Next, the tool change arm 16 moves in a direction away from the spindle 20 and the tool pot 12 (in the direction denoted by the arrow in the drawing), and the tool 13B is detached from the spindle 20 and the tool 13A is detached from the tool pot 12 (FIG. 6C). When the tool 13A is detached from the tool pot 12, the tool change arm 16 rotates, so that the tool 13A moves to the spindle 20 and the tool 13B moves to the tool pot 12 (FIG. 6D). Then, the tool change arm 16 moves in a direction of the spindle 20 and the tool pot 12 (in the direction denoted by the arrow in the drawing), and the tool 13A is attached to the spindle 20 and the tool 13B is housed in the tool pot 12. When the tool change arm 16 releases the tool 13A and the tool 13B, tool changing is completed (FIG. 6E).

In such an automatic tool changer, if tool indexing is not completed normally, serious damage may occur. For example, if positioning of a tool to be indexed is not correct, interference may occur between the tool and a mechanical section for changing a tool in a tool post and a tool in a spindle. If an incorrect tool pot is indexed to a tool change position, the tool in the tool pot may differ from an assumed tool in tool length, causing a collision between the tool and a workpiece. Thus, there is a danger that the machine tool main body, tool, or workpiece may be damaged, resulting in great damage.

There are various possible causes of a failure of normal completion of tool indexing. For example, normal operation or control may not be performed due to a failure or defect in the mechanical section caused by wear or inadequate lubrication, a failure or defect in an electrical component caused by vibration, entry of mist into cutting fluid, or the like, a defect in software, and so forth. It is extremely difficult to eliminate these failures and defects completely.

A technique for detecting such abnormalities in tool changing is disclosed in Japanese Patent Application Laid-Open No. 2001-232532 and Japanese Patent Application Laid-Open No. 11-333657.

However, in the technique described in the above patent documents, an abnormal load is detected when a tool in a tool post and a tool in a spindle are changed after tool indexing, but an abnormality is not detected in tool indexing. Because an abnormality is determined by comparing a motor load for driving a tool change arm with a motor load under normal conditions during tool changing, this technique has a problem in that an abnormality in tool indexing cannot be detected until tool change operation is performed.

### SUMMARY OF THE INVENTION

An object of the present invention is to provide a controller for a machine tool that can provide notification of an abnormality if tool indexing operation of an automatic tool changer is not performed normally due to a failure or defect.

A controller for a machine tool according to the present invention includes an automatic tool changer. The automatic tool changer includes a tool post that can house a plurality of tools and position a desired tool to a specific position, a tool post driving motor that drives the tool post, and a tool change mechanism that changes a tool indexed to a specific position in the tool post and a tool attached to a spindle. The controller includes: a movement amount estimation section that estimates an amount of movement of the tool post driving motor in tool indexing based on a tool pot number at a tool change position in the tool post before tool changing and a tool change instruction code; a motor movement amount acquisition section that acquires an amount of movement of the tool post driving motor in tool indexing; and an abnormality notification section that provides notification of an abnormality if a difference between the amount of movement of the tool post driving motor acquired by the motor movement amount acquisition section and the amount of movement of the tool post driving motor estimated by the movement amount estimation section has exceeded a permissible range.

The automatic tool changer may further include a maximum motor load value acquisition section that acquires a maximum value of tool post driving motor loads in tool indexing, and an abnormality notification section that provides notification of an abnormality if the maximum value of the tool post driving motor load acquired by the acquisition section is out of a permissible range.

According to the present invention, there can be provided a controller for a machine tool that can provide notification of an abnormality if tool indexing operation of an automatic tool changer is not performed normally due to a failure or defect.

### BRIEF DESCRIPTION OF THE DRAWINGS

The above and other objects and features of the present invention will be apparent from the following description of an embodiment with reference to the appended drawings, in which:

FIG. 1 is a graph illustrating changes in torque of a tool post driving motor in tool indexing in an embodiment of a controller according to the present invention;

FIG. 2 is a flowchart of abnormality notification processing in tool changing in the embodiment of the controller according to the present invention;

FIG. 3 is a flowchart continued from the flowchart in FIG. 2;

FIG. 4 is a flowchart continued from the flowchart in FIG. 3;

FIG. 5A is a side view illustrating an example of a mechanism of a tool changer with a tool post;

FIG. 5B is a front view of the mechanism of the tool changer in FIG. 5A;

FIG. 6A illustrates an example of a tool change arm of the tool changer; and

FIGS. 6B to 6E illustrate a procedure for tool change operation in the tool changer.

### DETAILED DESCRIPTION OF THE PREFERRED EMBODIMENTS

A description will first be given of a basic concept of a method for abnormality detection in tool changing with a controller according to the present invention.

Before a tool in a tool post and a tool in a spindle are changed, the controller according to the present invention checks if the relevant tool has been indexed correctly. In tool indexing that is performed by the controller, an amount of movement (amount of rotation) of a tool post driving motor is very important. To determine whether a specified tool is positioned to a correct position or not, it is necessary to estimate an amount of movement of the tool post driving motor in tool indexing in accordance with a tool change instruction, and compare the estimated amount of movement of the tool post driving motor with an actual amount of movement of the tool post driving motor in tool indexing. In addition, the load of the tool post driving motor is also checked, so that it becomes possible to detect an abnormality in tool indexing more reliably.

In the present invention, when “condition 1” below is satisfied, it is determined that positioning in tool indexing has been performed correctly. In addition, when “condition 2” below is satisfied, it is possible to detect an abnormality in tool indexing more reliably.

“Condition 1”: An amount of movement of the tool post driving motor in tool indexing is accurate.

“Condition 2”: Power is normally transmitted from the tool post driving motor to the tool post.

To determine whether “condition 1” above is satisfied or not, whether an amount of movement of the tool post driving motor in tool indexing is within a permissible range or not is checked. If an estimated amount of movement of the tool post driving motor is different from an actual amount of movement of the tool post driving motor acquired in tool indexing, it can be determined that the tool has not been indexed to a correct position.

To determine whether “condition 2” above is satisfied or not, whether a maximum value of tool post driving motor torque in tool indexing is within a permissible range or not is checked.

If the maximum value of tool post driving motor torque is smaller than the permissible range, it can be determined that power of the tool post driving motor is not transmitted and therefore the tool post is not driven (in other words, the tool post driving motor idles). Such a phenomenon may occur mainly in a machine tool in which a power transmission section is not fixed (for example, a machine tool of a type in which a spindle motor is used to drive a tool post) as disclosed in Japanese Patent Application Laid-Open No. 58-45835. In such a machine tool, the spindle motor moves to a position for driving the tool post only each time tool indexing is performed, and a positional relationship between the tool post and the motor that drives the tool post is not always fixed. If the positional relationship is collapsed, power of the spindle motor cannot be transmitted to the tool post and the tool cannot be indexed.

If the maximum value of tool post driving motor torque is larger than the permissible range, the tool post may not be used adequately (for example, the tool post is overweighted with tools) or the mechanical section may fail, for example.

The following will describe functions that the controller for the machine tool including the tool changer should have in order to detect “condition 1” and “condition 2” described above. The functions are implemented by operating the controller, with an arithmetic circuit constructed on the controller or through execution of a system program stored in a memory of the controller.

<1. Function of Estimating an Amount of Movement of the Motor in Tool Indexing>

The controller has a motor movement amount estimation function that estimates how far the tool post driving motor moves in tool indexing. When a tool change instruction is issued by a machining program or the like, this function calculates an estimated value Me of an amount of movement of the tool post driving motor required to move a tool to be changed to a tool change position, based on a tool pot number Tb at the tool change position at the start of tool changing and a tool pot number Ta of the tool to be changed specified by a code for the tool change instruction. The tool pot number currently at the tool change position can be acquired as an output value from the tool changer.

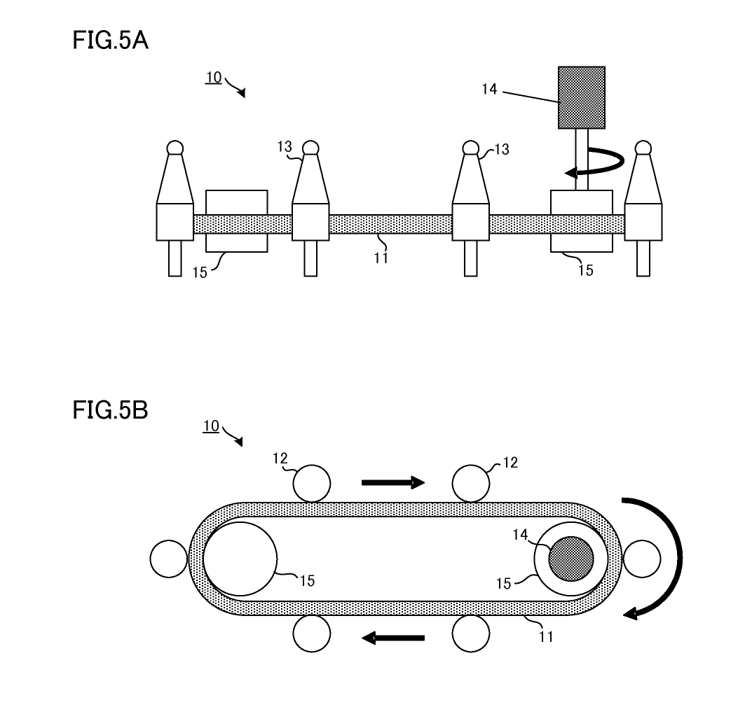

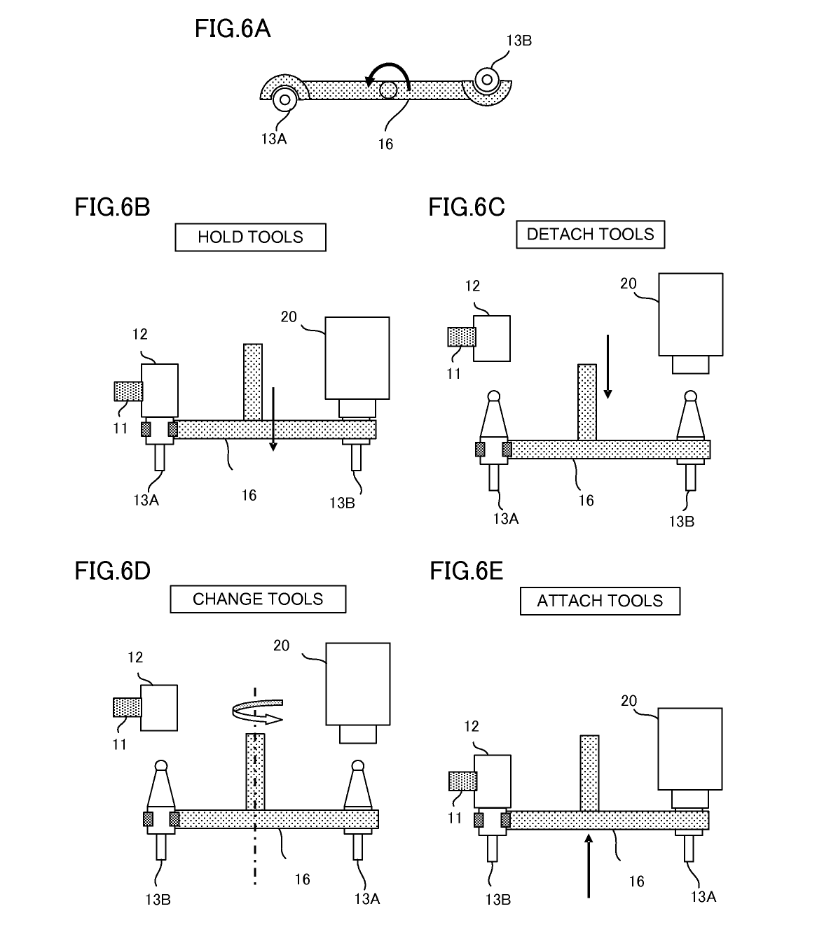

In general, in a tool post having a structure as illustrated in FIGS. 5A and 5B, tool pots are arranged at regular intervals, and an amount of movement D1 of the tool post driving motor required to move a tool pot to an adjacent tool pot is prestored in a memory or the like of the controller. If it is known how many consecutive tool pots the tool pot at the tool change position passes forward from the current tool pot, it is possible to estimate an amount of movement of the tool post driving motor in tool indexing. For example, if the tool pot number Tb at the tool change position at the start of tool changing is 1, and a tool change instruction specifies, for example, a tool indexing code “M6T5”, in which the tool pot number Ta of a tool to be changed is 5, then the tool pot should pass four consecutive tool pots. Therefore, the estimated value Me of an amount of movement of the motor in indexing is 4×D1.

<2. Function of Determining an Abnormality in an Amount of Movement of the Tool Post Driving Motor in Tool Indexing>

The above abnormality determination function determines whether an abnormality has occurred in an amount of movement of the tool post driving motor in tool indexing operation, based on the estimated value Me of the amount of movement of the tool post driving motor required to move the tool to be changed to the tool change position, the estimated value Me being estimated by the ‘function of estimating an amount of movement of the motor in tool indexing’. To acquire an amount of movement of the tool post driving motor, this function calculates an amount of movement of the tool post driving motor in tool change operation, based on a current position Pb of the tool post driving motor at the start of tool changing and a position Pa of the tool post driving motor after tool changing. Positional information of the tool post driving motor is acquired from a position detector mounted on the tool post driving motor.

When the roll-over function is enabled by which a position of the tool post driving motor returns to 0 if the position reaches a predetermined value, the position of the tool post driving motor does not suffice to determine an amount of movement in tool indexing. Therefore, the number of rotations R of coordinates of the tool post driving motor is counted. More specifically, the current position of the tool post driving motor is monitored at infinitesimal time intervals during tool indexing, and the count of the number of coordinate rotations R is incremented when the position has changed across the maximum values of positional coordinates.

Upon completion of tool indexing, from the position Pb of the tool post driving motor before indexing, the position Pa of the tool post driving motor after indexing, and the number of coordinate rotations R during tool indexing, an amount of movement Mc of the tool post driving motor in tool indexing is calculated as Mc=(Pa−Pb)+R×(amount of movement per rotation of the tool post driving motor).

The amount of movement Mc of the tool post driving motor in tool indexing and the estimated value Me of the amount of movement of the tool post driving motor that are thus calculated are compared. If a difference between the two values is larger than a permissible value Mp, it is determined that the amount of movement of the tool post driving motor in tool indexing is abnormal. The permissible value Mp may be, for example, an in-position value set in the tool post driving motor.

<3. Function of Determining an Abnormality in a Tool Post Driving Motor Load in Tool Indexing>

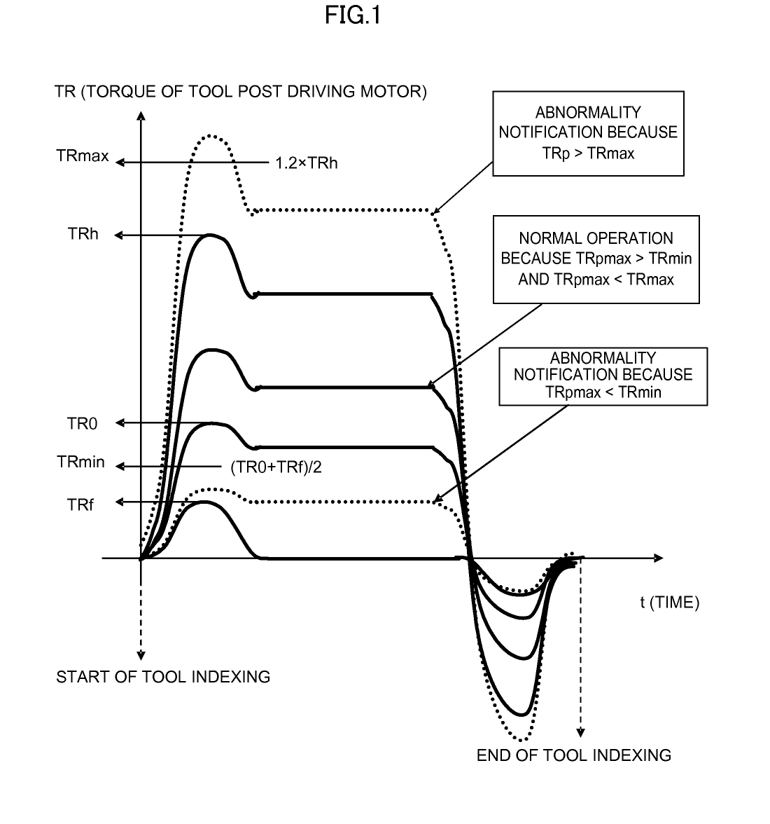

The above abnormality determination function determines whether an abnormality has occurred or not, based on a torque value TR generated in the tool post driving motor during tool indexing. In this function, as illustrated in FIG. 1, if an absolute value TRp of a torque value generated in the tool post driving motor during tool indexing is larger than a maximum permissible value TRmax, or if a maximum value TRpmax of acquired torque values is smaller than a minimum permissible value TRmin, it is determined that an abnormality has occurred in tool indexing. A torque value generated in the tool post driving motor can be acquired from a torque sensor or the like included in the tool post driving motor.

For the permissible values TRmax and TRmin of a tool post driving motor load in tool indexing, tool changer characteristics are measured in advance and prestored in a memory included in the controller.

Examples of how to obtain the permissible values are explained below with reference to FIG. 1.

The minimum permissible value TRmin can be obtained from the following equation.

TRmin=(TR0+TRf)/2

where TR0 is a maximum value of a torque value generated in the tool post driving motor, which is measured when tool indexing is performed with no tools housed in the tool post, and TRf is a maximum value of a torque value generated in the tool post driving motor when the tool post driving motor is caused to idle without transmitting power to the tool post,

The maximum permissible value TRmax can be obtained from the following equation.

TRmax=TRh×1.2

where TRh is a maximum value of a torque value generated in the tool post driving motor when tool indexing is performed with the tool post housing tools at the upper limit of allowable weight,

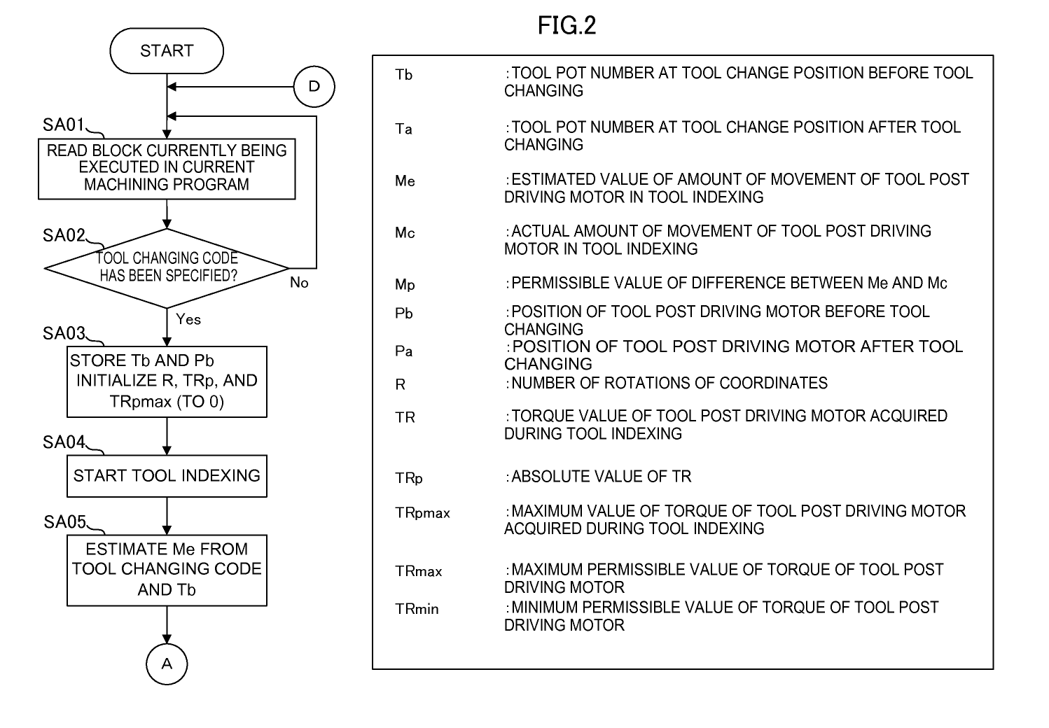

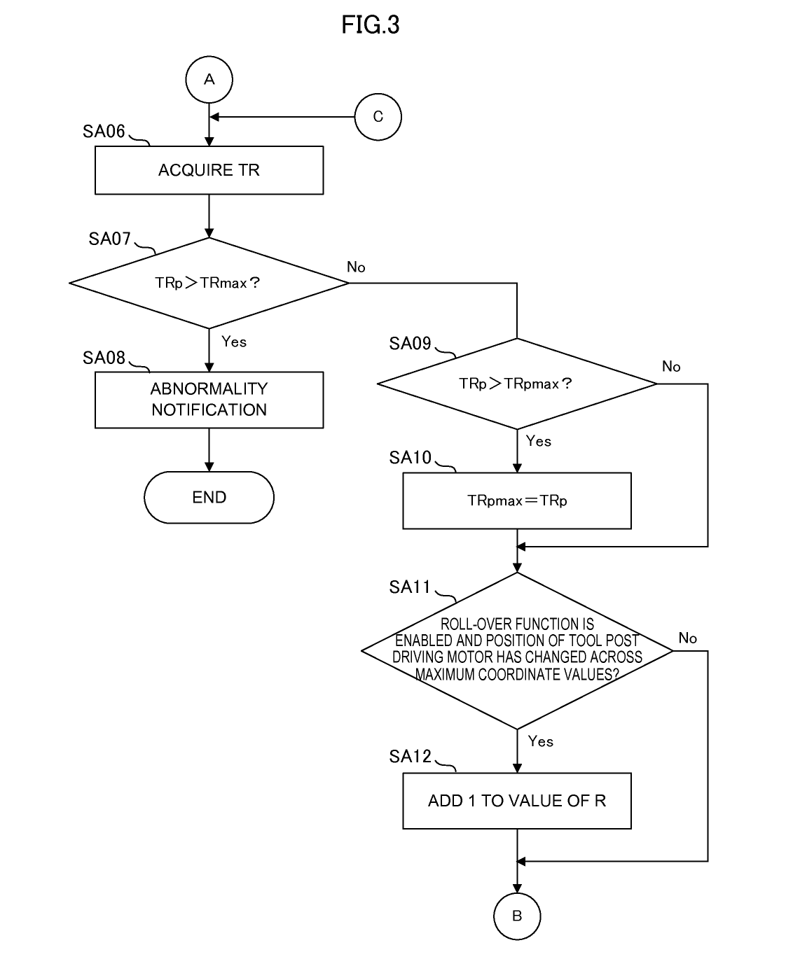

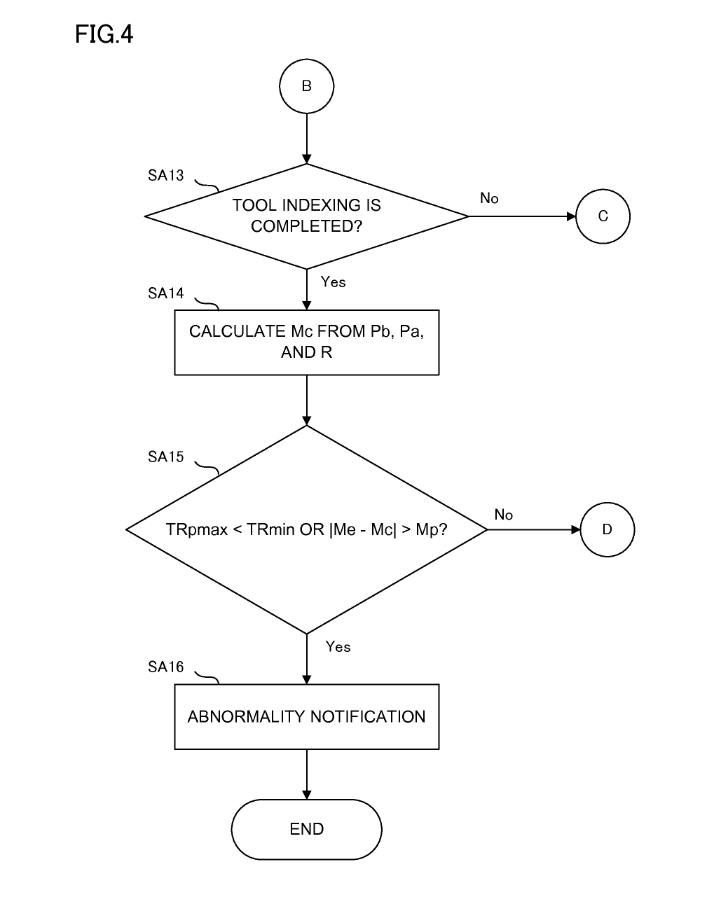

A procedure performed by the controller having these functions for abnormality notification processing in tool changing will be described with reference to flowcharts in FIGS. 2 to 4.

[Step SA01] A block currently being executed in the current machining program is read.

[Step SA02] In the read block, a determination is made as to whether a code for a tool change instruction has been specified or not. If the code for the tool change instruction has been specified, the flow proceeds to step SA03. Otherwise, the flow returns to step SA01.

[Step SA03] The tool pot number Tb at the tool change position before tool changing and the current position Pb of the tool post driving motor at the start of tool changing are stored. The number of rotations R of coordinates of the tool post driving motor, the absolute value TRp of a torque value of the tool post driving motor, and the maximum value TRpmax of torque of the tool post driving motor acquired during tool indexing are initialized to 0.

[Step SA04] The tool changer is controlled to start tool indexing operation.

[Step SA05] Based on the tool pot number Tb at the tool change position before tool changing stored in step SA03 and the tool pot number Ta of the tool to be changed specified by the code for the tool change instruction, the estimated value Me of an amount of movement of the tool post driving motor required to move the tool to be changed to the tool change position is calculated.

[Step SA06] The torque value TR of the tool post driving motor is acquired at infinitesimal time intervals during tool indexing, and the absolute value TRp of the torque value TR of the tool post driving motor is calculated during tool indexing.

[Step SA07] A determination is made as to whether or not the absolute value TRp of the torque value of the tool post driving motor calculated in step SA06 has exceeded the permissible value TRmax of a tool post driving motor load in tool indexing. If TRp has exceeded TRmax, the flow proceeds to step SA08. Otherwise, the flow proceeds to step SA09.

[Step SA08] It is determined that an abnormality has occurred in the torque of the tool post driving motor in tool indexing. Notification is provided that the absolute value TRp of the torque value of the tool post driving motor has exceeded the permissible value TRmax of the tool post driving motor load in tool indexing (that is, abnormality notification is provided). Then, the abnormality notification processing in tool changing is ended.

[Step SA09] A determination is made as to whether or not TRp calculated in step SA06 has exceeded the maximum value TRpmax of a torque value of the tool post driving motor acquired during tool indexing. If TRp has exceeded TRpmax, the flow proceeds to step SA10. Otherwise, the flow proceeds to step SA11.

[Step SA10] The value of TRpmax is updated with the value of TRp calculated in step SA06.

[Step SA11] A determination is made as to whether or not the roll-over function of the tool post driving motor is enabled and the position of the tool post driving motor has changed across the maximum values of coordinates. If the position of the tool post driving motor has changed across the maximum values of the coordinates, the flow proceeds to step SA12. Otherwise, the flow proceeds to step SA13.

[Step SA12] The number of rotations R of coordinates of the tool post driving motor is incremented by 1.

[Step SA13] A determination is made as to whether tool indexing operation is completed or not. If tool indexing operation is completed, the flow proceeds to step SA14. Otherwise, the flow returns to step SA06.

[Step SA14] The position Pa of the tool post driving motor after the end of tool indexing operation is acquired. The amount of movement Mc of the tool post driving motor in tool indexing is calculated on the basis of the acquired position Pa, the current position Pb of the tool post driving motor at the start of tool changing, and the number of rotations R of coordinates of the tool post driving motor.

[Step SA15] A determination is made as to whether or not the maximum value TRpmax of the torque value of the tool post driving motor acquired during tool indexing has fallen below the minimum permissible value TRmin of a tool post driving motor load in tool indexing. A determination is also made as to whether or not an absolute value of a difference between the estimated value Me of the amount of movement of the tool post driving motor required to move the tool to be changed to the tool change position and the amount of movement Mc of the tool post driving motor in tool indexing has exceeded the permissible value Mp. As a result of the determinations, if either or both of the following hold true, the flow proceeds to step SA16. Otherwise, the flow returns to step SA01.

TRpmax<TRmin

|Me−Mc|>Mp

[Step SA16] It is determined that an abnormality has occurred in the tool post driving motor in tool indexing. Based on the determination result, notification is provided that the torque value is small or the amount of movement of the tool post driving motor is out of the permissible range (abnormality notification). Then, the abnormality notification processing in tool changing is ended.

Thus, the controller for the machine tool including the tool changer in the embodiment of the present invention can detect occurrence of an abnormality in tool changing and provide abnormality notification. The controller is capable of control such as stop of the machine or output of a warning, based on abnormality notification. Upon abnormality notification, control operation as described below may be performed, for example.
Operation 1 upon abnormality notification: If an amount of movement of the tool post driving motor in tool indexing is out of a permissible range, and if a load of the tool post driving motor is smaller than a permissible value, the machine is stopped upon detection of an abnormality because a collision may occur between the mechanical section of the tool changer and a tool.
Operation 2 upon abnormality notification: If torque of the tool post driving motor is larger than a permissible range, a warning is output, prompting a check to see if there is no abnormality in the mechanical section of the tool changer and if the upper limit of weight of tools that can be mounted on the tool post is not significantly exceeded.

Although the embodiment of the controller for the machine tool according to the present invention has been described above, the present invention is not limited to examples of the above embodiment, and can be implemented in other aspects by making appropriate changes. For example, the above method for calculating the estimated value Me of an amount of movement of the tool post driving motor is an example in a case in which the tool pots are arranged at regular intervals in the tool post. In addition to this, for example, an amount of movement of the tool post driving motor required for movement between tool pots may be measured in advance by experiments and the like and stored in advance on a memory in table format, and an estimated value of an amount of movement may be obtained from the table. An estimated value of an amount of movement may be computed by, for example, a function expression that reflects the structure of the tool post and the tool post driving motor. Such a configuration is also applicable in a case where the tool pots are not arranged at regular intervals in the tool post.

Further, setting of the permissible values TRmax and TRmin of a tool post driving motor load is not limited to the examples described above. More appropriate values may be set in response to tool changer characteristics, or such values may be dynamically determined on the basis of information, such as installation environment for the machine tool, acquired by a sensor or the like.

1. A controller for a machine tool including an automatic tool changer, the automatic tool changer including
a tool post that can house a plurality of tools and position a desired tool to a specific position,
a tool post driving motor that drives the tool post, and
a tool change mechanism that changes a tool indexed to a specific position in the tool post and a tool attached to a spindle,
the controller comprising:
a movement amount estimation section that estimates an amount of movement of the tool post driving motor in tool indexing based on a tool pot number at a tool change position in the tool post before tool changing and a tool change instruction code;
a motor movement amount acquisition section that acquires an amount of movement of the tool post driving motor in tool indexing; and
an abnormality notification section that provides notification of an abnormality if a difference between the amount of movement of the tool post driving motor acquired by the motor movement amount acquisition section and the amount of movement of the tool post driving motor estimated by the movement amount estimation section has exceeded a permissible range.

2. The controller for the machine tool including the automatic tool changer according to claim 1, wherein the automatic tool changer further includes a maximum motor load value acquisition section that acquires a maximum value of tool post driving motor loads in tool indexing and an abnormality notification section that provides notification of an abnormality if the maximum value of the tool post driving motor load acquired by the acquisition section is out of a permissible range.
